(19) United States
(12) Patent Application Publication
(10) Pub. No.: US 2022/0398850 A1
(43) Pub. Date: Dec. 15, 2022

(54) INFORMATION GENERATION DEVICE, INFORMATION GENERATION METHOD, AND NON-TRANSITORY COMPUTER-READABLE STORAGE MEDIUM

(71) Applicant: SUMITOMO ELECTRIC INDUSTRIES, LTD., Osaka-shi, Osaka (JP)

(72) Inventors: Shohei OGAWA, Osaka-shi (JP); Kyohiro YOSHIDA, Osaka-shi (JP)

(73) Assignee: SUMITOMO ELECTRIC INDUSTRIES, LTD., Osaka-shi, Osaka (JP)

(21) Appl. No.: 17/770,229

(22) PCT Filed: Nov. 15, 2019
(86) PCT No.: PCT/JP2019/044975

§ 371 Date: Apr. 19, 2022

(51) Int. Cl. G06V 20/54; G06T 7/60; G06T 7/20; G06T 7/70; G08G 1/017; G01S 13/91

(52) U.S. Cl. CPC G06V 20/54; G06T 7/60; G06T 7/20; G06T 7/70; G08G 1/0175; G01S 13/91; G06T 2207/30236; G06V 2201/08; G06T 2207/30242

(57) ABSTRACT

An information generation device includes: a measurement unit configured to obtain a plurality of measurement results by performing a measurement of a vehicle size with respect to a same traveling vehicle a plurality of times; a detection unit configured to detect an accuracy of each of the plurality of measurement results; and a determination unit configured to determine a vehicle size of the traveling vehicle from the plurality of measurement results on the basis of the accuracies.

### TECHNICAL FIELD

The present disclosure relates to an information generation device, an information generation method, and a computer program.

### BACKGROUND ART

To date, various systems for supporting driving of a vehicle that travels on a road have been proposed (see PATENT LITERATURE 1).

In such a driving support, detection of a vehicle is required. The vehicle is detected by a sensor such as a radar sensor or a camera, for example.

PATENT LITERATURE 2 discloses a traveling-vehicle grasping device that grasps the state of a vehicle by means of a radar sensor. The radar sensor of PATENT LITERATURE 2 is installed at a plurality of places on a road, and applies a pulse laser beam to vehicles.

PATENT LITERATURE 3 discloses a vehicle type discriminating device that discriminates a vehicle type on the basis of image data obtained by a camera that photographs a vehicle. The vehicle type discriminating device of PATENT LITERATURE 3 uses a grid-like pattern provided on a road, and photographs a vehicle traveling on the pattern. The vehicle type discriminating device calculates a vehicle length on the basis of image data obtained through the photographing, and discriminates a vehicle type on the basis of the calculated vehicle length.

### CITATION LIST

### Patent Literature

PATENT LITERATURE 1: Japanese Laid-Open Patent Publication No. 2003-288686
PATENT LITERATURE 2: Japanese Laid-Open Patent Publication No. 2000-20876
PATENT LITERATURE 3: Japanese Laid-Open Patent Publication No. H6-309588

### SUMMARY OF THE INVENTION

An aspect of the present disclosure is an information generation device. The information generation device of the disclosure includes: a measurement unit configured to obtain a plurality of measurement results by performing a measurement of a vehicle size with respect to a same traveling vehicle a plurality of times; a detection unit configured to detect an accuracy of each of the plurality of measurement results; and a determination unit configured to determine a vehicle size of the traveling vehicle from the plurality of measurement results on the basis of the accuracies.

Another aspect of the present disclosure is an information generation method. The information generation method of the disclosure includes: obtaining a plurality of measurement results by performing a measurement of a vehicle size with respect to a same traveling vehicle a plurality of times; detecting an accuracy of each of the plurality of measurement results; and determining a vehicle size of the traveling vehicle from the plurality of measurement results on the basis of the accuracies.

Another aspect of the present disclosure is a computer program. The computer program of the disclosure is for causing a computer to operate as an information generation device. The information generation device includes: a measurement unit configured to obtain a plurality of measurement results by performing a measurement of a vehicle size with respect to a same traveling vehicle a plurality of times; a detection unit configured to detect an accuracy of each of the plurality of measurement results; and a determination unit configured to determine a vehicle size of the traveling vehicle from the plurality of measurement results on the basis of the accuracies.

### BRIEF DESCRIPTION OF DRAWINGS

FIG. 1 shows an overall configuration of a traffic information providing system according to a first embodiment.

FIG. 2 is a block diagram showing a configuration of a traffic flow measuring device according to the first embodiment.

FIG. 3 shows a measurement result of each measurement point outputted from a sensor.

FIG. 4 is a diagram for describing a method for determining a vehicle length performed by a vehicle length determination unit.

FIG. 5 shows an example of information stored in a storage unit.

FIG. 6 is a flow chart showing an example of a processing procedure of the traffic flow measuring device according to the first embodiment.

FIG. 7 shows an overall configuration of a traffic information providing system according to a second embodiment.

FIG. 8 is a block diagram showing a configuration of a driving support device according to the second embodiment.

FIG. 9 is a flow chart showing an example of a processing procedure of the driving support device according to the second embodiment.

FIG. 10 illustrates an inter-vehicle distance.

### DETAILED DESCRIPTION

### Problems to be Solved by the Present Disclosure

When a vehicle is to be detected by a sensor such as a radar sensor or a camera, it is advantageous if the area in which the vehicle can be detected by a single sensor is large. That is, when the detectable area is large, the installation number of sensors can be reduced, and thus, the installation cost can be suppressed.

However, when the vehicle detectable area is large, the measurement accuracy of a vehicle size such as a vehicle length may vary depending on the position in the area. For example, when the technology disclosed in PATENT LITERATURE 3 is used, the grid-like pattern is viewed to be small at a location far from the camera, and thus, the measurement accuracy of the vehicle length is deteriorated. In the case of a radar sensor as well, the measurement accuracy of the vehicle size may vary depending on the position of the measurement.

Therefore, it is desired that the vehicle size such as the vehicle length is accurately obtained.

### Description of Embodiments of the Present Disclosure

(1) An information generation device according to an embodiment includes: a measurement unit configured to obtain a plurality of measurement results by performing a measurement of a vehicle size with respect to a same traveling vehicle a plurality of times; a detection unit configured to detect an accuracy of each of the plurality of measurement results; and a determination unit configured to determine a vehicle size of the traveling vehicle from the plurality of measurement results on the basis of the accuracies. With this configuration, out of a plurality of vehicle size measurement results with respect to the same traveling vehicle, a vehicle size of which the accuracy is good can be determined as the vehicle size. Therefore, even when a plurality of measurement results include a measurement result of which the accuracy is bad, the vehicle size can be appropriately determined.

(2) Preferably, the determination unit is configured to determine, as the vehicle size, a measurement result of which the accuracy is highest among the plurality of measurement results. In this case, the measurement result of which the accuracy is highest is determined as the vehicle size.

(3) Preferably, the plurality of measurement results are measurement results measured at a plurality of positions, respectively. When a vehicle size is measured at each of a plurality of times, the traveling vehicle moves and will be present at different positions. In this case, the plurality of measurement results will be measurement results measured at the plurality of positions, respectively.

(4) Preferably, the information generation device further includes a tracking unit configured to judge vehicles detected at the plurality of positions to be the same traveling vehicle. The tracking unit can judge vehicles detected at a plurality of positions to be the same traveling vehicle.

(5) Preferably, the information generation device further includes a vehicle type determination unit configured to determine a vehicle type of the traveling vehicle on the basis of the vehicle size determined by the determination unit. In this case, a vehicle type can be accurately determined on the basis of a vehicle size of which the accuracy is good.

(6) Preferably, the information generation device further includes a flow measuring unit configured to measure a traffic flow for each vehicle type on the basis of the vehicle type determined by the vehicle type determination unit. In this case, the traffic flow for each vehicle type can be accurately measured on the basis of the vehicle type accurately determined.

(7) Preferably, the traffic flow for each vehicle type includes the number of vehicles for each vehicle type. In this case, the number of vehicles for each vehicle type can be accurately measured. The number of vehicles is measured as the number of vehicles for each predetermined time period, for example.

(8) Preferably, the information generation device further includes a providing unit configured to provide first information based on the vehicle size determined by the determination unit. In this case, the first information based on the determined vehicle size can be used for driving support for another vehicle. The driving of another vehicle may be driving by a person, or may be automated driving.

(9) Preferably, the first information is further based on a position of the traveling vehicle. In this case, the first information based on the vehicle size determined and the position of the traveling vehicle can be provided. Accordingly, driving support for another vehicle becomes more appropriate.

(10) Preferably, the information providing unit is configured to further provide second information indicating a measurement time of the position. In this case, another vehicle can also use the measurement time of the position of the traveling vehicle.

(11) The first information includes inter-vehicle data with respect to a first traveling vehicle and a second traveling vehicle traveling behind the first traveling vehicle. The determined vehicle size indicates at least a vehicle length. The inter-vehicle data is obtained at least by using the vehicle length indicated by the vehicle size of the first traveling vehicle.

(12) Preferably, the inter-vehicle data includes at least one of an inter-vehicle distance and an inter-vehicle time length. The inter-vehicle distance or the inter-vehicle time length with respect to the first traveling vehicle and the second traveling vehicle are useful in driving support for another vehicle that is going to enter between the first traveling vehicle and the second traveling vehicle.

(13) Preferably, the first information is for being provided to a vehicle that is going to enter a lane on which the first traveling vehicle and the second traveling vehicle are traveling. A vehicle that is going to enter a lane on which the first traveling vehicle and the second traveling vehicle are traveling can smoothly enter the lane on which the first traveling vehicle and the second traveling vehicle are traveling, by using the first information including the inter-vehicle data.

(14) Preferably, the vehicle size indicates at least a vehicle length. Preferably, the information generation device further includes a providing unit configured to provide first information based on the vehicle length indicated by the vehicle size and a position of the traveling vehicle. Preferably, the first information is for being provided to another vehicle. Another vehicle is a vehicle that is going to enter a lane on which the traveling vehicle is traveling, for example.

(15) Preferably, each measurement result is obtained on the basis of image data obtained by photographing a road. Preferably, the accuracy is detected on the basis of the number of pixels included in an image of the traveling vehicle in the image data. In many cases, a vehicle that is viewed to be large in image data has a high accuracy of the measurement result. Therefore, the accuracy can be detected by using the number of pixels included in the image of the traveling vehicle.

(16) Preferably, the measured vehicle length is obtained on the basis of a cluster of measurement points obtained from a reflected wave of a transmission wave applied to a road by a radar sensor. Preferably, the accuracy is detected on the basis of the number of the measurement points included in the cluster. In many cases, the greater the number of measurement points is, the higher the measurement accuracy of the measured vehicle size is. Therefore, the accuracy can be detected by using the number of measurement points.

(17) Preferably, the measured vehicle size is obtained on the basis of a reflected wave of a transmission wave applied to a road by a radar sensor. Preferably, the accuracy is detected on the basis of a position of the traveling vehicle of which the vehicle size has been measured. For example, when the relationship between the position of the vehicle and the measurement error of the vehicle size is previously investigated, the accuracy of the vehicle size can be detected from the position of the vehicle on the basis of the investigation result.

(18) An information generation method according to the embodiment includes: obtaining a plurality of measurement results by performing a measurement of a vehicle length with respect to a same traveling vehicle a plurality of times; detecting a measurement accuracy of each of the plurality of measurement results; and determining a vehicle length of the traveling vehicle from the plurality of measurement results on the basis of the accuracies.

(19) A computer program according to the embodiment causes a computer to operate as an information generation device. The information generation device includes: a measurement unit configured to obtain a plurality of measurement results by performing a measurement of a vehicle size with respect to a same traveling vehicle a plurality of times; a detection unit configured to detect an accuracy of each of the plurality of measurement results; and a determination unit configured to determine a vehicle size of the traveling vehicle from the plurality of measurement results on the basis of the accuracies.

It is understood that the computer program described above can be distributed via a computer-readable non-transitory storage medium such as a CD-ROM (Compact Disc-Read Only Memory) or a communication network such as the Internet. A part or the entirety of the information generation device may be realized by a semiconductor integrated circuit. The information generation device may be used in a system that includes the information generation device.

### Details of Embodiment of the Present Disclosure

Hereinafter, embodiments of the present disclosure will be described in detail with reference to the drawings. The embodiments described below are preferable specific examples of the present disclosure. Numerical values, shapes, materials, components, arrangement positions and connection forms of components, steps, the order of steps, and the like shown in the embodiments below are merely examples, and are not intended to limit the present disclosure. The present disclosure is specified by the claims. Therefore, among the components in the embodiments below, components that are not described in the independent claims, which represent the highest-order concept of the present disclosure, are not necessarily required in order to achieve the problem addressed by the present disclosure, but are described as components for realizing more preferable embodiments.

The same components are denoted by the same reference signs. Since those components have similar functions and names, descriptions thereof are omitted as appropriate.

### First Embodiment

<Overall Configuration of Traffic Information Providing System>

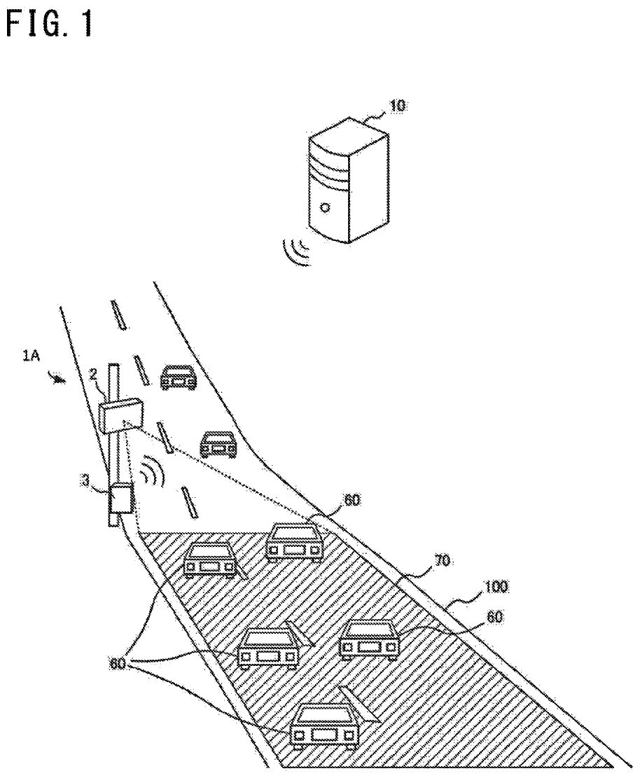

FIG. 1 shows an overall configuration of a traffic information providing system according to a first embodiment.

A traffic information providing system 1 is a system that measures the traffic flow of vehicles 60 traveling on a road 100. The traffic information providing system 1 includes a sensor 2 and a traffic flow measuring device 3 serving as an information generation device.

The sensor 2 is a radar sensor, for example. The radar sensor transmits a radio wave (transmission wave) to an area 70 on the road 100, and receives a reflected wave of the transmission wave. The area 70 has a length of several hundred meters in the traveling direction of each vehicle 60, for example.

On the basis of the received reflected wave, the sensor 2 obtains a plurality of measurement points that correspond to objects in the area 70. The measurement points are, for example, places at which the level of the reflected wave is greater than a threshold for detection. The sensor 2 receives the reflected wave from the plurality of measurement points of the objects in the area 70, and on the basis of the received reflected wave, measures the distance from the sensor 2 to each measurement point, the direction (horizontal angle) of each measurement point relative to the sensor 2, and the speed of each measurement point. The plurality of measurement points are subjected to clustering as described later, for vehicle detection.

As an example, the sensor 2 is configured so as to include a transmission antenna and a plurality of reception antennas of which the installation positions are different. The sensor 2 measures the position, direction, and speed of each measurement point from the reflected wave, by using a frequency modulated continuous wave (FM-CW) method. The sensor 2 outputs a measurement result including the position, direction, and speed of the measurement point, to the traffic flow measuring device 3 serving as an information generation device. The radio wave is a millimeter wave in a 24 GHz band, a 79 GHz band, or a 76 GHz band, for example. Instead of the radio wave, the transmission wave may be an ultrasonic wave having a frequency of 20 kHz or higher.

As shown in FIG. 1, for example, the sensor 2 is installed at a position at which each vehicle 60 traveling upstream of the sensor 2 can be measured from the front face of the vehicle 60. However, the installation position of the sensor 2 is not limited thereto. For example, the sensor 2 may be installed at a position at which each vehicle 60 traveling downstream of the sensor 2 can be measured from behind the vehicle 60. The sensor 2 may be installed at a position at which each vehicle 60 can be measured from above or a side of the vehicle 60.

The traffic flow measuring device 3 receives the measurement result from the sensor 2 and measures the traffic flow of vehicles 60 traveling on the road 100. The traffic flow includes at least one of the number of vehicles per unit time, and the average speed, for example. The traffic flow is measured for each vehicle type. That is, the number of vehicles is measured for each vehicle type, and the average speed is also measured for each vehicle type. The traffic flow measuring device 3 transmits traffic information indicating the measured traffic flow, to a central device 10. The traffic flow measuring device 3 transmits the traffic information to the central device 10 by using a communication network such as a mobile phone network or a dedicated wireless or wired line. For example, the central device 10 is a server installed in a traffic control center or the like.

<Configuration of Traffic Flow Measuring Device>

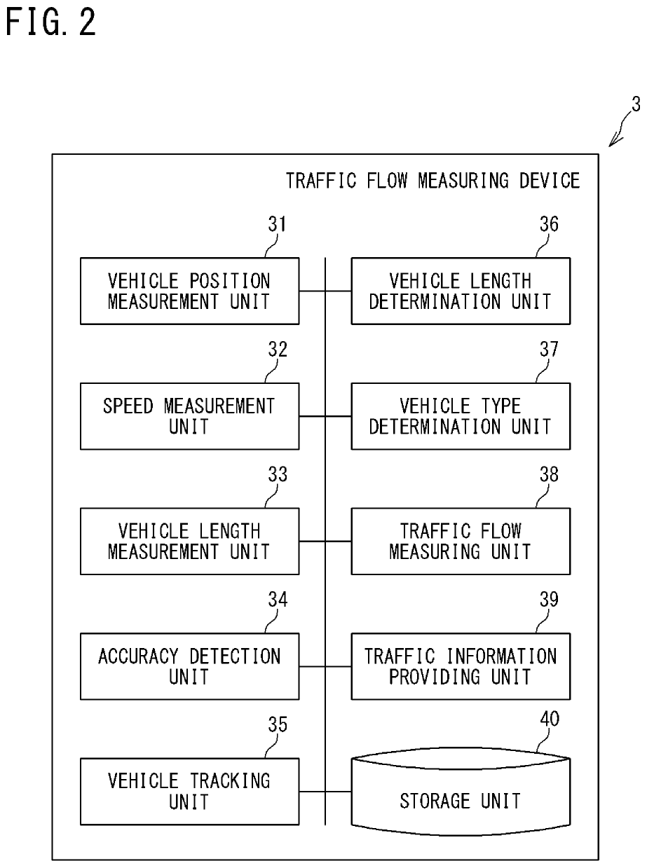

FIG. 2 is a block diagram showing a configuration of the traffic flow measuring device 3 according to the first embodiment.

The traffic flow measuring device 3 includes: a vehicle position measurement unit 31, a speed measurement unit 32, a vehicle length measurement unit 33, an accuracy detection unit 34, a vehicle tracking unit 35, a vehicle length determination unit 36, a vehicle type determination unit 37, a traffic flow measuring unit 38, a traffic information providing unit 39, and a storage unit 40.

The traffic flow measuring device 3 may be implemented as a computer that includes a CPU (Central Processing Unit), a ROM (Read Only Memory), a RAM (Random Access Memory), a communication I/F (interface), and the like. Each processing unit 31 to 39 is functionally realized by executing a computer program on a CPU.

The vehicle position measurement unit 31 measures the position of each vehicle 60. More specifically, the vehicle position measurement unit 31 measures the position of each vehicle 60 on the basis of a measurement result of each measurement point outputted from the sensor 2.

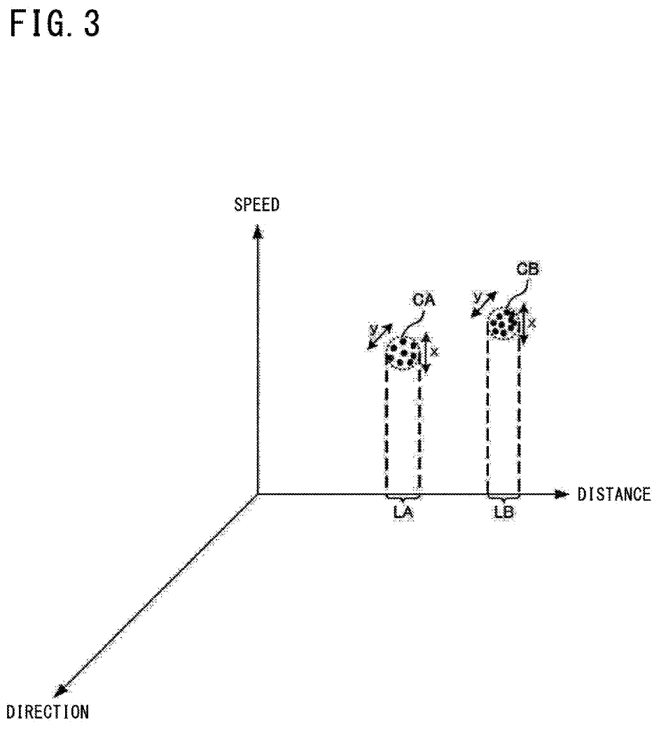

With reference to FIG. 3, a method for measuring the position of a vehicle 60 is described. FIG. 3 shows a measurement result of each measurement point outputted from the sensor 2. The measurement result of each measurement point is expressed as a point (black dot in FIG. 3) in a three-dimensional space composed of distance, direction, and speed.

The vehicle position measurement unit 31 clusters points (black dots in FIG. 3) in the space. For example, the vehicle position measurement unit 31 clusters points of which the speed is within x (km/h) and of which the direction is within y(°), into one cluster. Here, the measurement points are classified into two clusters, i.e., clusters CA and CB. One cluster represents one vehicle 60. Thus, for each cluster, the vehicle position measurement unit 31 specifies the point having the smallest distance, as the point of the leading end position of the vehicle 60 that corresponds to the cluster. The vehicle position measurement unit 31 calculates a leading end position on the basis of the distance and direction that correspond to the point of the leading end position, thereby measuring the leading end position of the vehicle 60 as the position of the vehicle 60. The position can be represented as a two-dimensional coordinate, for example.

In a case where the sensor 2 measures a vehicle 60 traveling downstream of the sensor 2, the vehicle position measurement unit 31 may measure the rear end position of the vehicle 60, as the position of the vehicle 60. In a case where the sensor 2 measures a vehicle 60 from above or a side of the vehicle 60, the vehicle position measurement unit 31 may measure a previously-set position, out of the leading end position and the rear end position of the vehicle 60, as the position of the vehicle 60.

The vehicle position measurement unit 31 stores, into the storage unit 40, for each vehicle 60, information of the measured position of the vehicle 60, in association with information of the measurement time of the position.

The speed measurement unit 32 measures the speed of each vehicle 60 on the basis of a measurement result of each measurement point outputted from the sensor 2.

With reference to FIG. 3, a method for measuring the speed of a vehicle 60 is described. As described above, measurement points by the sensor 2 are classified into a cluster for each vehicle 60. Therefore, on the basis of the speeds corresponding to the measurement points included in each cluster, the speed measurement unit 32 measures the speed of the vehicle 60 that corresponds to the cluster. For example, the speed measurement unit 32 may measure the average value or the median of the speeds of the measurement points included in a cluster, as the speed of the vehicle 60 that corresponds to the cluster. The speed measurement unit 32 stores information of the measured speed of the vehicle 60, into the storage unit 40.

The vehicle length measurement unit (vehicle size measurement unit) 33 measures the vehicle length of each vehicle 60. More specifically, the vehicle length measurement unit 33 measures the vehicle length of each vehicle 60 on the basis of the measurement result of each measurement point outputted from the sensor 2. For example, for each cluster, the vehicle length measurement unit 33 measures the difference between the largest value and the smallest value of the distance of the measurement points included in the cluster, as the vehicle length of the vehicle 60 that corresponds to the cluster. In the example shown in FIG. 3, the vehicle length of the vehicle 60 that corresponds to the cluster CA is measured as LA, and the vehicle length of the vehicle 60 that corresponds to the cluster CB is measured as LB.

Since the cluster CA, CB also indicates a vehicle width, the vehicle size measurement unit 33 can also measure a vehicle width on the basis of the cluster CA, CB. Depending on the installation position of the sensor 2, the cluster CA, CB indicates a vehicle height. Therefore, the vehicle size measurement unit 33 can also measure a vehicle height on the basis of the cluster CA, CB.

The vehicle length measurement unit 33 stores, into the storage unit 40, information regarding the measured vehicle size such as the vehicle length (measured vehicle length) of the vehicle 60 that has been measured. The measured vehicle size (e.g., measured vehicle length) stored here is a vehicle size as a provisional value.

The accuracy detection unit 34 detects the measurement accuracy of the measurement result (measured vehicle length) of the vehicle length measured by the vehicle length measurement unit 33. More specifically, on the basis of the measurement result of each measurement point outputted from the sensor 2, the accuracy detection unit 34 judges the accuracy of the measurement result of the vehicle length of the vehicle 60.

With reference to FIG. 3, a method for detecting the accuracy of the measurement result of the vehicle length is described. As described above, measurement points by the sensor 2 are classified into a cluster for each vehicle 60. The greater the number of measurement points included in a cluster of each vehicle 60 is, the higher the accuracy of the measurement result of the vehicle length of the vehicle 60 is. Therefore, on the basis of the number of measurement points included in the cluster of each vehicle 60, the accuracy detection unit 34 obtains the accuracy of the measurement result of the vehicle length of the vehicle 60. The accuracy detection unit 34 may use the number itself of measurement points included in the cluster of each vehicle 60, as the accuracy of the measurement result of the vehicle length of the vehicle 60, or may use an index obtained from the number of measurement points, as the accuracy.

The accuracy detection unit 34 stores, into the storage unit 40, information of the accuracy (measurement accuracy; vehicle length accuracy) of the measurement result of the vehicle length of the vehicle 60.

That is, in the storage unit 40, for each vehicle 60, information of the position of the vehicle 60, the measurement time of the position, the speed, the vehicle length, and the accuracy of the measurement result of the vehicle length are stored.

The traffic flow measuring device 3 detects each vehicle 60 of which the position changes due to traveling in the area 70, at each of a plurality of positions in the area 70. That is, the vehicle position measurement unit 31 measures the vehicle position of the same vehicle, at each of the plurality of positions in the area 70. The speed measurement unit 32 measures the speed of the same vehicle, at each of the plurality of positions in the area 70. The vehicle length measurement unit 33 measures the speed of the same vehicle, at each of the plurality of positions in the area 70.

Therefore, the information of the measurement time of the position of the vehicle 60, the speed, the vehicle length, and the accuracy of the measurement result of the vehicle length is measured or detected at each of the plurality of positions in the area 70, and is stored into the storage unit 40 for each of the plurality of positions.

The vehicle tracking unit 35 tracks each vehicle 60. The vehicle tracking unit 35 operates so as to judge traveling vehicles 60 detected at a plurality of positions in the area 70, to be the same vehicle. More specifically, on the basis of information for each vehicle 60 stored in the storage unit 40, the vehicle tracking unit 35 associates pieces of information of vehicles 60 having different measurement times, with each other, thereby tracking a vehicle 60. For example, using a Kalman filter, the vehicle tracking unit 35 estimates, from the information of the position, the speed, and the like of a first vehicle at a first measurement time, the position of the first vehicle at a second measurement time. The vehicle tracking unit 35 judges that a second vehicle having a measurement position at a second measurement time nearest to the estimated position of the first vehicle is the same vehicle as the first vehicle, thereby tracking the first vehicle.

The vehicle tracking unit 35 provides the same vehicle ID (identifier) to the first vehicle and the second vehicle determined to be the same vehicle, and stores the vehicle ID into the storage unit 40.

The vehicle length determination unit 36 obtains a determined vehicle size (determined vehicle length) as a definitive value, from a measured vehicle length (measured vehicle size) as a provisional value. On the basis of the tracking result of the vehicle by the vehicle tracking unit 35 and the judgement result about the accuracy of the measurement result of the vehicle length by the accuracy detection unit 34, the vehicle length determination unit 36 compares the accuracies of measurement results of the vehicle length of the same traveling vehicle. The vehicle length determination unit 36 determines the vehicle length of the vehicle on the basis of the comparison result of the accuracy. In the embodiment, the vehicle length determination unit 36 determines a vehicle length judged to have the highest accuracy among the vehicle lengths of the same vehicle, to be the vehicle length (determined vehicle length) of the vehicle.

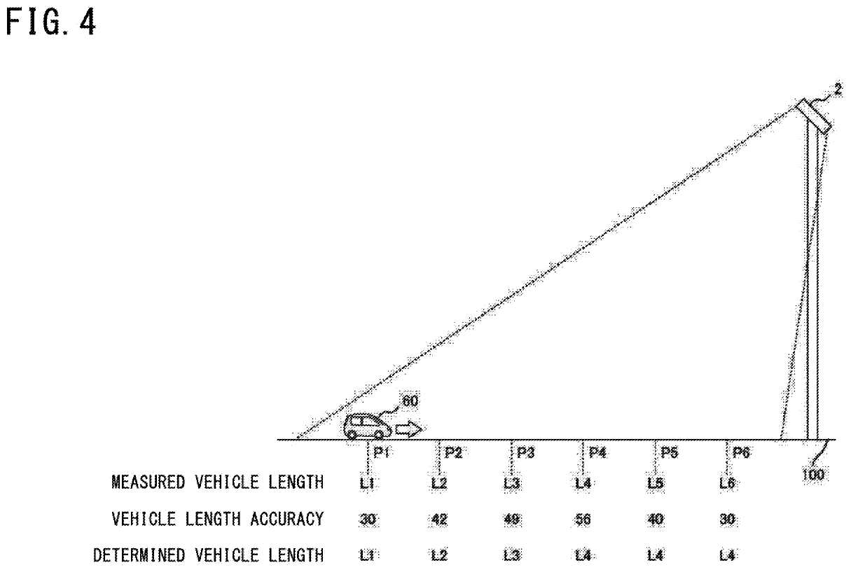

FIG. 4 is a diagram for describing a method for determining a vehicle length performed by the vehicle length determination unit. With reference to FIG. 4, the vehicle 60 is assumed to travel in the area 70 on the road 100, in the order of positions P1, P2, P3, P4, P5, P6. The vehicle length measurement unit 33 measures the vehicle length of the vehicle 60 at each position P1, P2, P3, P4, P5, P6. The accuracy detection unit 34 obtains an accuracy (hereinafter, referred to as “vehicle length accuracy”) of each of measurement results of the vehicle lengths having been measured (hereinafter, referred to as “measured vehicle lengths”). For example, it is assumed that a set of a measured vehicle length and a vehicle length accuracy of the vehicle 60 at the position P1 is (L1, 30), and the above-described sets at the positions P2 to P6 are (L2, 42), (L3, 49), (L4, 56), (L5, 40), (L6, 30), respectively.

That is, it is assumed that, in accordance with increase in the distance from the position P1, the vehicle length accuracy of the vehicle 60 has increased to be highest at the position P4, but thereafter, the vehicle length accuracy has decreased. The reason for this is as follows. At a position far from the sensor 2, the number of measurement points of the vehicle 60 is small and thus the vehicle length accuracy is low. Meanwhile, also when the vehicle 60 is too close to the sensor 2, the number of measurement points included in one cluster decreases due to influence of noise.

The vehicle length determination unit 36 determines the vehicle length of the vehicle 60 in the order of the positions P1, P2, P3, P4, P5, P6. At each position, the vehicle length determination unit 36 determines, as the vehicle length (determined vehicle length) of the vehicle 60 at the position, a measured vehicle length that has the highest vehicle length accuracy among the measured vehicle lengths of the vehicle 60 having been measured by that time.

For example, at the position P1, the vehicle length determination unit 36 has measured only the measured vehicle length L1, and the measured vehicle length L1 is the highest accuracy. Thus, the vehicle length determination unit 36 sets the measured vehicle length L1 as the determined vehicle length. At the position P2, the vehicle length accuracy “42” of the measured vehicle length L2 is the highest accuracy among the vehicle length accuracies of the measured vehicle lengths L1 and L2. Thus, the vehicle length determination unit 36 sets the measured vehicle length L2 as the determined vehicle length. Similarly, at the positions P3 and P4, the vehicle length determination unit 36 sets the measured vehicle lengths L3 and L4 as the determined vehicle lengths, respectively.

Further, at the position P5, the vehicle length accuracy “56” of the measured vehicle length L4 is the highest accuracy among the vehicle length accuracies of the measured vehicle lengths L1 to L5. Thus, the vehicle length determination unit 36 sets the measured vehicle length L4 as the determined vehicle length. At the position P6, the vehicle length accuracy “56” of the measured vehicle length L4 is the highest accuracy among the vehicle length accuracies of the measured vehicle lengths L1 to L6. Thus, the vehicle length determination unit 36 sets the measured vehicle length L4 as the determined vehicle length.

As described above, up to the position P4 to which the vehicle length accuracy continues to increase, the determined vehicle length is sequentially updated. However, after the position P4, the vehicle length accuracy continues to decrease, and thus, the determined vehicle length is not updated.

The vehicle length determination unit 36 may determine the vehicle lengths at the positions P1 to P6 after the vehicle 60 has passed through the area 70. In this case, since the vehicle length accuracy “56” of the measured vehicle length L4 is the highest accuracy among the vehicle length accuracies of the measured vehicle lengths L1 to L6, the vehicle length determination unit 36 may determine that all of the determined vehicle lengths of the positions P1 to P6 to be L4. The vehicle length determination unit 36 stores the determined vehicle length into the storage unit 40.

With reference to FIG. 2 again, the vehicle type determination unit 37 determines the vehicle type of the vehicle 60 on the basis of the vehicle length determined by the vehicle length determination unit 36. For example, when the determined vehicle length is not less than 5.5 m, the vehicle type determination unit 37 determines the vehicle type of the vehicle 60 to be a large vehicle. When the determined vehicle length is less than 5.5 m, the vehicle type determination unit 37 determines the vehicle type of the vehicle 60 to be a small vehicle.

With respect to the same vehicle 60, there are cases where the vehicle length is different depending on the position. In such a case, the vehicle type determination unit 37 may determine the vehicle type on the basis of the vehicle length that has the highest accuracy. That is, in the example shown in FIG. 4, the vehicle type determination unit 37 determines the vehicle type on the basis of the determined vehicle length L4 at the position P4 at which the vehicle length accuracy is highest.

In a case where the vehicle width or vehicle height can be measured instead of the vehicle length, the vehicle type determination unit 37 may determine the vehicle type by subjecting the vehicle width or vehicle height to threshold processing. The vehicle type determination unit 37 stores the determined vehicle type into the storage unit 40.

The storage unit 40 is implemented by a storage device such as a HDD (Hard Disk Drive) or a flash memory, and stores the various kinds of information described above.

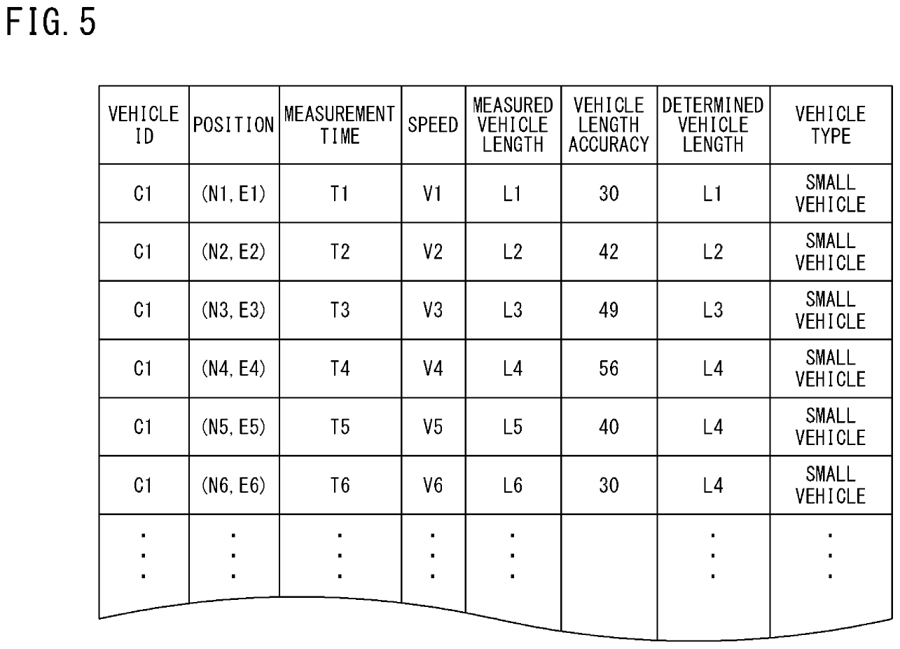

FIG. 5 shows an example of information stored in the storage unit 40.

In the storage unit 40, a vehicle ID, a position, a measurement time, a measured vehicle length, a vehicle length accuracy, a determined vehicle length, and a vehicle type of each vehicle 60 is stored as a set. For example, information of a vehicle ID “C1” is information of the same vehicle tracked by the vehicle tracking unit 35.

The traffic flow measuring unit 38 measures the traffic flow of vehicles 60 for each vehicle type on the basis of tracking results by the vehicle tracking unit 35. As an example, with reference to information stored in the storage unit 40, the traffic flow measuring unit 38 measures, as a traffic flow, each of the number of large vehicles and the number of small vehicles that have passed through the area 70 in a certain time period. While regarding pieces of information of vehicles 60 that have been determined to be the same vehicle by the vehicle tracking unit 35 and have been provided with the same vehicle ID, as information of the same vehicle 60, the traffic flow measuring unit 38 measures the number of vehicles 60. The traffic flow is not limited to the number of vehicles 60, and may be the average speed of vehicles 60, for example. The average speed can also be measured for each vehicle type.

The traffic information providing unit 39 transmits, as traffic information to the central device 10, the information of the traffic flow of vehicles 60 for each vehicle type measured by the traffic flow measuring unit 38, thereby providing traffic information.

<Processing Procedure of Traffic Flow Measuring Device>

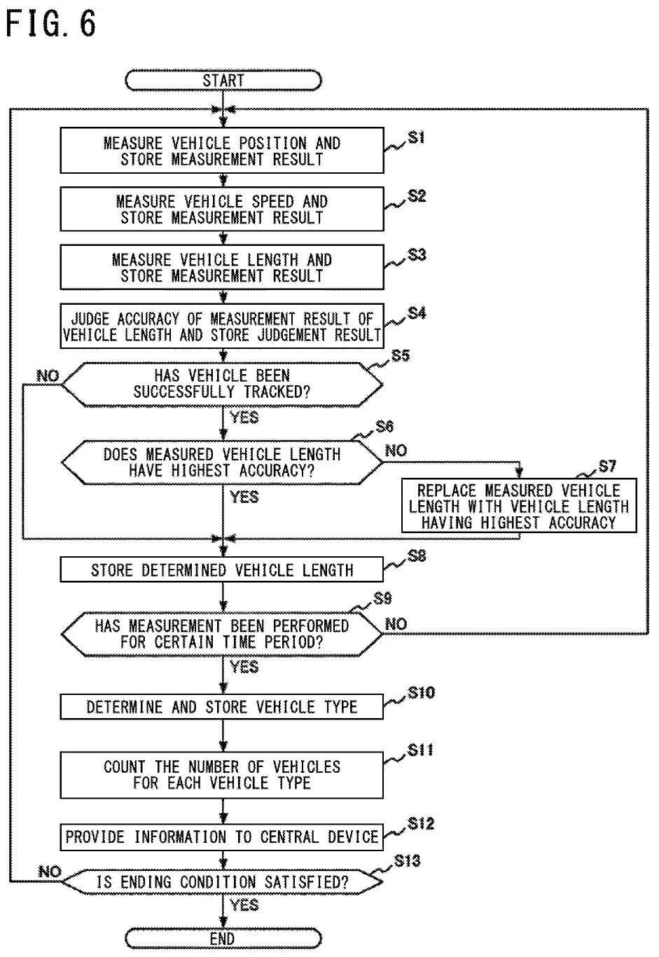

FIG. 6 is a flow chart showing an example of a processing procedure of the traffic flow measuring device according to embodiment 1 of the present disclosure.

With reference to FIG. 6, on the basis of the measurement result of each measurement point outputted from the sensor 2, the vehicle position measurement unit 31 measures the position of a vehicle 60, and stores the measurement result together with the vehicle ID of the vehicle 60, into the storage unit 40 (S1). The vehicle position measurement unit 31 generates a value that has not been provided as a vehicle ID, at random or as a serial number, for example, and provides the generated value as the vehicle ID.

On the basis of the measurement result of each measurement point outputted from the sensor 2, the speed measurement unit 32 measures the speed of the vehicle 60, and stores the measurement result into the storage unit 40 (S2). The measurement result is associated with the vehicle ID generated in step S1.

On the basis of the measurement result of each measurement point outputted from the sensor 2, the vehicle length measurement unit 33 measures the vehicle length of the vehicle 60, and stores the measured vehicle length into the storage unit 40 (S3). The measured vehicle length is associated with the vehicle ID generated in step S1.

On the basis of the measurement result of each measurement point outputted from the sensor 2, the accuracy detection unit 34 judges the accuracy of the measurement result of the vehicle length of the vehicle 60, and stores the judged vehicle length accuracy into the storage unit 40 (S4). The vehicle length accuracy is associated with the vehicle ID generated in step S1.

On the basis of information for each vehicle 60 stored in the storage unit 40, the vehicle tracking unit 35 associates pieces of information of vehicles 60 having different measurement times, with each other, thereby tracking a vehicle 60 (S5). The vehicle tracking unit 35 updates the vehicle ID such that the vehicle IDs of the associated pieces of information have the same value.

When the vehicle 60 has been successfully tracked (YES in S5), the vehicle length determination unit 36 judges whether or not the vehicle length measured in step S3 has the highest accuracy among the vehicle lengths having the same vehicle ID (S6).

When the measured vehicle length does not have the highest accuracy (NO in S6), the vehicle length determination unit 36 replaces the vehicle length that has been measured, with the vehicle length having the highest accuracy, thereby determining the vehicle length after the replacement to be the vehicle length of the vehicle 60 (S7).

Then, the vehicle length determination unit 36 stores the determined vehicle length into the storage unit 40 (S8). The determined vehicle length is associated with the vehicle ID.

When the measured vehicle length has the highest accuracy (YES in S6), the vehicle length determination unit 36 determines the measured vehicle length to be the vehicle length of the vehicle 60, and stores the measured vehicle length into the storage unit 40 in association with the vehicle ID (S8).

When tracking of the vehicle 60 has failed (YES in S5), the measured vehicle length of the vehicle 60 is determined to be the vehicle length of the vehicle 60, and is caused to be stored into the storage unit 40 in association with the vehicle ID.

On the basis of an output of a timer or the like, the vehicle type determination unit 37 determines whether or not a certain time period (e.g., 1 minute) has elapsed after the start of the process of step S1 (S9).

When the certain time period has not elapsed (NO in S9), and the processes of step S1 and thereafter are repeatedly executed. Through the repetition of the processes of step S1 and thereafter, the vehicle position, the vehicle speed, and the vehicle length are measured a plurality of times for the same traveling vehicle. The measurement accuracy of the vehicle length is detected for each of the plurality of measured vehicle lengths.

When the certain time period has elapsed (YES in S9), the vehicle type determination unit 37 determines, on the basis of pieces of information stored in the storage unit 40, a vehicle type from the determined vehicle length for each piece of information, and stores the determined vehicle type into the storage unit 40 in association with the vehicle ID (S10). Through the processes up to this point, information as shown in FIG. 5 is stored into the storage unit 40.

The traffic flow measuring unit 38 refers to the information stored in the storage unit 40, and measures, as a traffic flow, each of the number of large vehicles and the number of small vehicles that have passed through the area 70 in the certain time period (S11).

The traffic information providing unit 39 transmits, to the central device 10 as traffic information, information of the traffic flow of vehicles 60 for each vehicle type measured by the traffic flow measuring unit 38, thereby providing traffic information (S12).

The traffic flow measuring device 3 determines whether or not a predetermined ending condition is satisfied (S13). For example, when having received a signal that instructs stop of the processing in the traffic flow measuring device 3 from outside, the traffic flow measuring device 3 may determine that the ending condition is satisfied.

When the ending condition is satisfied (YES in S13), the traffic flow measuring device 3 ends the processing. When the ending condition is not satisfied (NO in S13) the processes of step S1 and thereafter are repeatedly executed.

<Effect of First Embodiment>

As described above, according to the first embodiment, a vehicle 60 is tracked, and with respect to the same traveling vehicle 60, the accuracy of a measurement result of a vehicle length measured at a certain position at a certain time is compared with the accuracy of a measurement result of a vehicle length measured at another position at another time. Then, on the basis of the comparison result, the vehicle length of the vehicle 60 can be determined. Accordingly, a vehicle length having a higher accuracy can be adopted and determined to be the vehicle length of the vehicle 60. According to this configuration, even when the area 70 has a place where the measurement accuracy of the vehicle size is low due to enlargement of the area 70 in which the vehicle 60 is detected, use of a vehicle size having a low measurement accuracy can be avoided. Therefore, the area 70 can be made large, and the installation number of the sensor can be suppressed. Accordingly, the vehicle length of the vehicle 60 can be highly accurately determined at low installation cost.

In addition, a vehicle 60 that has a greater number of measurement points of a reflected wave with respect to an applied radio can be judged to have a higher accuracy of the measurement result of the vehicle length. Therefore, the accuracy of the measurement result of the vehicle length can be accurately judged.

In addition, a vehicle type can be determined on the basis of a vehicle length that has a high accuracy, and the traffic flow for each vehicle type can be measured. Specifically, the number of vehicles 60 according to the kind of vehicle type for each predetermined time period can be measured. Therefore, the traffic flow for each vehicle type can be highly accurately measured.

[First Modification of First Embodiment]

In the first embodiment described above, a radar sensor is used as an example of the sensor 2. However, the sensor 2 is not limited to a radar sensor. As the sensor 2, another device that can observe the area 70 substantially at the same time can be used. For example, as the sensor 2, a camera can be used or a LiDAR (Light Detection and Ranging) can be used.

In the first modification, a case where a camera is used as the sensor 2 is described. In this case, the vehicle position measurement unit 31 of the traffic flow measuring device 3 specifies the position of the vehicle 60 by performing image processing on image data obtained by the camera photographing the area 70. For example, the vehicle position measurement unit 31 specifies the position of the vehicle 60 by using a background difference method or the like. That is, the vehicle position measurement unit 31 binarizes differential data between image data outputted from the camera and background image data obtained by photographing the area 70 at a time point when no vehicle 60 is included, whereby the vehicle position measurement unit 31 creates binarized image data. The vehicle position measurement unit 31 extracts images of vehicles 60 from the binarized image data, and estimates a position for each vehicle 60. For example, in the binarized image data, an uppermost position is specified for each image of the vehicle 60, and a position in a three-dimensional space (real space) corresponding to the position is specified as the position of the vehicle 60. It should be noted that the relationship between the position in the image data and the position in the three-dimensional space is assumed to be known through calibration and the like previously performed.

On the basis of the image of the vehicle 60 in the binarized image data, the vehicle length measurement unit 33 measures the vehicle length of the vehicle 60 from the length of the image. It should be noted that the relationship between the vehicle length and the length of the image at each position in the image data is assumed to be known through calibration and the like previously performed.

On the basis of the image of the vehicle 60 in the binarized image data, the accuracy detection unit 34 judges the accuracy of the measurement result of the vehicle length measured by the vehicle length measurement unit 33. For example, the accuracy detection unit 34 may judge that the greater the number of pixels included in the image of the vehicle 60 is, the higher the accuracy of the measurement result of the vehicle length is. That is, the accuracy detection unit 34 may judge the accuracy from the number of pixels on the basis of table information indicating the relationship between the number of pixels and the accuracy.

When a camera is used as the sensor 2, the vehicle tracking unit 35 may track a vehicle 60, for example, by recognizing the number plate from image data outputted from the camera and by associating vehicles 60 that have the same number between frames, with each other.

[Second Modification of First Embodiment]

The accuracy detection unit 34 of the traffic flow measuring device 3 of the first embodiment described above detects the accuracy of the measurement result of the vehicle length on the basis of the number of measurement points included in a cluster. However, the accuracy detection method is not limited thereto.

For example, by using a vehicle 60 for an experiment conducted in advance, for each position of the vehicle 60, an error between a correct vehicle length and a vehicle length measured by the vehicle length measurement unit 33 at the position is obtained. Then, relationship information, between the position of the vehicle 60 and the accuracy of the measurement result of the vehicle length, in which a position that has a smaller error has a higher accuracy of the measurement result of the vehicle length, is obtained.

During operation, the accuracy detection unit 34 refers to this relationship information, and on the basis of the position of the vehicle 60 measured by the vehicle position measurement unit 31, the accuracy detection unit 34 detects the accuracy of the measurement result of the vehicle length of the vehicle 60 present at that position.

Instead of obtaining the above-described relationship information from the position of the experimental vehicle 60 and the error in the vehicle length, relationship information may be obtained on the basis of a horizontal angle or elevation angle up to the experimental vehicle 60, and an error between a true value and the measurement value of the horizontal angle or elevation angle, for example.

According to the second modification, for example, when the relationship between the position of the vehicle and the measurement error of the vehicle length is previously investigated, the accuracy of the measurement result of the vehicle length can be detected from the position of the vehicle 60 on the basis of the relationship information being the investigation result. Accordingly, the accuracy of the measurement result of the vehicle length can be accurately detected.

### Second Embodiment

<Overall Configuration of Traffic Information Providing System>

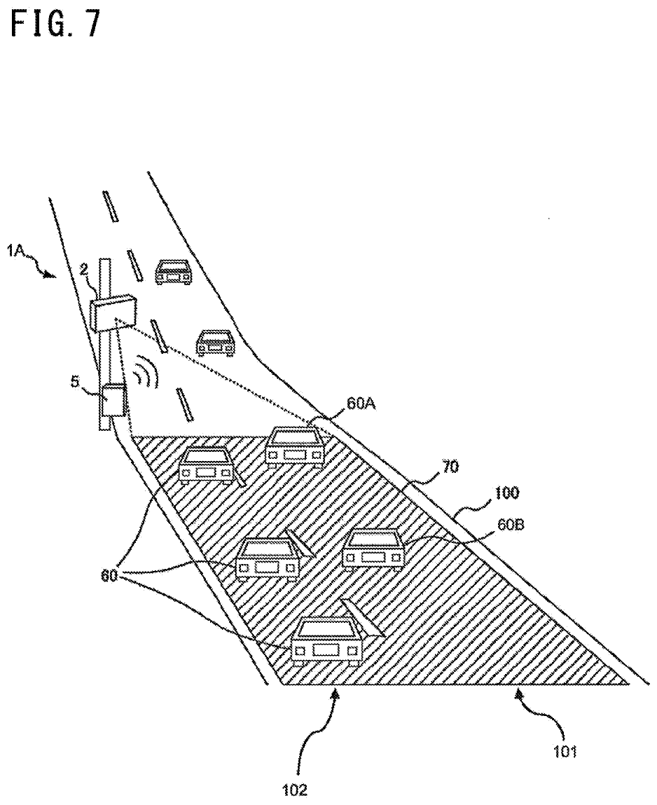

FIG. 7 shows an overall configuration of a traffic information providing system according to a second embodiment.

A traffic information providing system 1A is a system for supporting driving of a vehicle, and includes a sensor 2 and a driving support device 5 as an information generation device. The driving support device 5 of the embodiment supports driving of a vehicle 60 that is going to enter a certain lane 101 from outside the lane 101.

In the following, as the entering of the lane 101, an example in which lane changing from a second lane 102 included in a road 100 to a first lane 101 included in the road 100 is assumed and described. However, the entering of the lane 101 may be entering the road 100 from a position outside the road 100, such as a parking lot.

The sensor 2 is a radar sensor similar to that in the first embodiment. For example, as shown in FIG. 7, the sensor 2 is installed at a position at which vehicles 60, 60A, 60B traveling in an area 70 upstream of the sensor 2 can be measured from the front face of each vehicle 60, 60A, 60B. The area 70 in which the vehicle 60, 60A, 60B is detected by the sensor 2 includes the first lane 101 and the second lane 102 of the road 100. Similar to the first embodiment, the sensor 2 may be installed at a position at which the vehicle 60, 60A, 60B traveling in the area 70 can be measured from behind the vehicle 60, 60A, 60B. The sensor 2 may be installed at a position at which the vehicle 60, 60A, 60B can be measured from above or a side of the vehicle 60, 60A, 60B.

In the following, described is driving support to be provided to a vehicle 60 traveling on the second lane 102, when the vehicle 60 is to perform lane changing to the first lane 101 in which a first traveling vehicle 60A and a second traveling vehicle 60B are traveling. For providing lane changing support to the vehicle 60, information regarding the vehicle 60A, 60B traveling on the first lane is provided to the vehicle 60. However, the driving support described below is also used when the vehicle 60A, 60B traveling on the first lane 101 is to perform lane changing to the second lane 102.

The driving support device 5 receives measurement results from the sensor 2, and provides first information based on the position and the vehicle length of the vehicle 60A, 60B traveling on the first lane 101. For example, the driving support device 5 may provide, to the vehicle 60 traveling on the second lane 102, information of the position and the vehicle length of the vehicle 60A, 60B traveling on the first lane 101, as vehicle information (first information). The driving support device 5 may create, as the vehicle information (first information), information such as an inter-vehicle distance between the vehicle 60 and the vehicle 60B and an inter-vehicle time length between the vehicle 60A and the vehicle 60B, on the basis of the position and the vehicle length of the vehicle 60A, 60B, and may provide this vehicle information to the vehicle 60. The vehicle 60A, 60B traveling on the first lane 101 and the vehicle 60 traveling on the second lane 102 are distinguished from each other by the position (direction) of the vehicle measured by the sensor 2.

<Configuration of Driving Support Device>

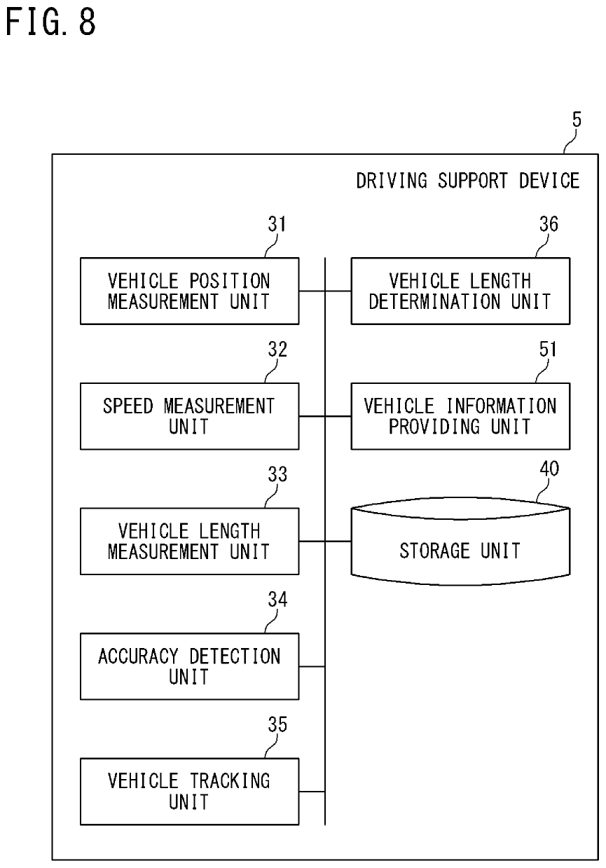

FIG. 8 is a block diagram showing a configuration of the driving support device 5 according to the second embodiment.

The driving support device 5 includes a vehicle position measurement unit 31, a speed measurement unit 32, a vehicle length measurement unit 33, an accuracy detection unit 34, a vehicle tracking unit 35, a vehicle length determination unit 36, a vehicle information providing unit 51, and a storage unit 40.

The driving support device 5 may be implemented as a computer that includes a CPU, a ROM, a RAM, a communication I/F, and the like. Each processing unit 31 to 36 and 51 is functionally realized by executing a computer program on a CPU.

The processing units 31 to 36 are the same as those shown in the first embodiment. Thus, detailed description thereof is not repeated here.

The vehicle information providing unit 51 generates vehicle information (first information) on the basis of the position of each vehicle 60A, 60B measured by the vehicle position measurement unit 31 and the vehicle length of the vehicle 60A, 60B determined by the vehicle length determination unit 36. The vehicle information (first information) is information for supporting lane changing to the first lane 101 of the vehicle 60 traveling on the second lane 102. The vehicle information providing unit 51 wirelessly transmits the generated vehicle information (first information) to the vehicle 60. The vehicle information may be received by the vehicle 60A, 60B.

Preferably, the vehicle information (first information) according to the embodiment includes information based on a determined vehicle size (determined vehicle length) at least. The information based on the determined vehicle size (determined vehicle length) may be the determined vehicle size (determined vehicle length) itself, or information obtained from the determined vehicle size (determined vehicle length). Preferably, the vehicle information (first information) includes information based on the position of a vehicle. The information based on the position of a vehicle may be the position of the vehicle itself, or may be information obtained from the position of the vehicle. For example, the vehicle information providing unit 51 may generate, as the vehicle information (first information), information of the position and the vehicle length (determined vehicle length) of the vehicle 60A, 60B traveling on the first lane 101.

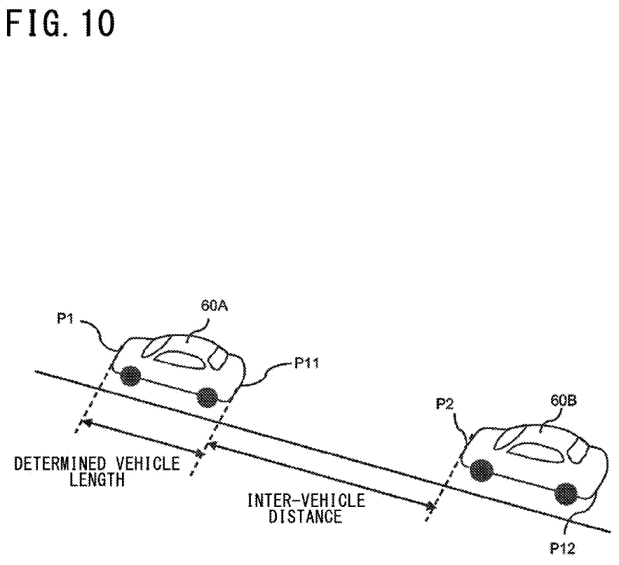

The vehicle information providing unit 51 may generate, as the vehicle information (first information), inter-vehicle data that includes information of an inter-vehicle distance and an inter-vehicle time period of a vehicle 61. Specifically, on the basis of the positions of the vehicles 60A, 60B and the vehicle length of each vehicle 60A, 60B, the vehicle information providing unit 51 specifies a leading end position P1, P2 and a rear end position P11, P12 for each vehicle 60A, 60B (see FIG. 10). For example, the vehicle information providing unit 51 specifies the rear end position P12 of the vehicle 61 by adding together the leading end position P1 of the vehicle 60A measured by the vehicle position measurement unit 31, and the vehicle length (determined vehicle length). For each set of vehicles 60A, 60B adjacent to each other in the front-rear direction and traveling on the first lane 101, the vehicle information providing unit 51 calculates an inter-vehicle distance (inter-vehicle data) being the distance from the rear end position P11 of the front vehicle 60A to the leading end position P2 of the rear vehicle 60B. The vehicle information providing unit 51 may calculate, from the inter-vehicle distance and the speed of the rear vehicle 60B, the time period necessary for the rear vehicle 60B to travel the inter-vehicle distance, as the inter-vehicle time length (inter-vehicle data).

The inter-vehicle data is useful when the vehicle 60 other than the vehicles 60A, 60B is going to travel between the vehicle 60A and the vehicle 60B. Traveling of the vehicle 60 between the vehicle 60A and the vehicle 60B occurs by the vehicle 60 performing lane changing, for example. Traveling of the vehicle 60 between the vehicle 60A and the vehicle 60B also occurs when the vehicle 60 crosses an opposite lane and turns at an intersection. For example, as in Japan, in a country where vehicles travel on a left lane, crossing an opposite lane at an intersection occurs at the time of right-turning. In such a case, the inter-vehicle data is useful.

The vehicle information providing unit 51 transmits the created vehicle information (first information) to the vehicle 60. Accordingly, the vehicle 60 traveling on the second lane 102 can determine a lane changing position or lane changing timing to the first lane 101, and can smoothly perform lane changing.

When transmitting the vehicle information, the vehicle information providing unit 51 may transmit information (second information) of the measurement time of the position and the like of the vehicle 60A, 60B, in association with the vehicle information (first information). Depending on the communication state between the driving support device 5 and the vehicle 60, a time lag may be caused before the vehicle 60 receives the vehicle information provided by the vehicle information providing unit 51. However, with this configuration, information of the measurement time of the position and the like of the vehicle 60A, 60B can be provided to the vehicle 60. Therefore, on the vehicle 60 side, the position of the vehicle 60A, 60B can be corrected on the basis of the measurement time and the current time. Accordingly, the vehicle 60 traveling on the second lane 102 can accurately determine a lane changing position, a lane changing timing, and the like to the first lane 101.

In a case where the vehicle information (first information) to be provided to the vehicle 60 includes the positions of the vehicles 60A, 60B and the determined vehicle length of each vehicle 60A, 60B but does not include the inter-vehicle data, the vehicle 60 having received the vehicle information may generate inter-vehicle data from the positions of the vehicles 60A, 60B and the determined vehicle length of each vehicle 60A, 60B.

In the storage unit 40, information similar to that shown in FIG. 5 is stored. However, information of the vehicle type is not stored.

<Processing Procedure of Driving Support Device>

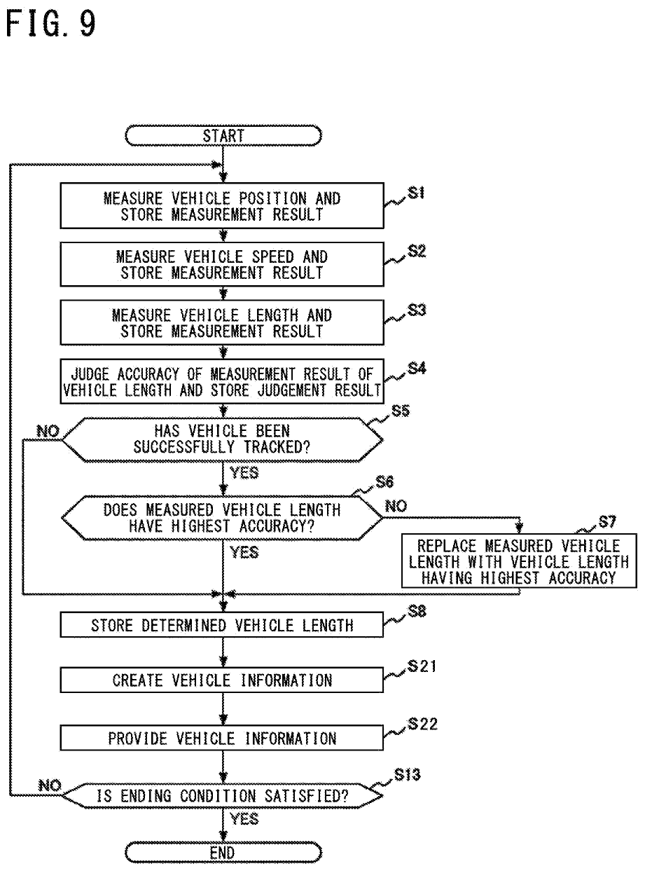

FIG. 9 is a flow chart showing an example of a processing procedure of the driving support device 5 according to the second embodiment.

With reference to FIG. 9, the driving support device 5 executes the processes of steps S1 to S8. These processes are the same as those described with reference to FIG. 6. Therefore, detailed description thereof is not repeated here.

The vehicle information providing unit 51 creates vehicle information for supporting lane changing to the first lane 101 of the vehicle 60 traveling on the second lane 102, on the basis of the position of the vehicle 61 measured by the vehicle position measurement unit 31 and the determined vehicle length of the vehicle 61 determined by the vehicle length determination unit 36 (S21).

The vehicle information providing unit 51 wirelessly transmits the created vehicle information to the vehicle 60, thereby providing the vehicle information (S22).

The driving support device 5 determines whether or not an ending condition similar to that described in the first embodiment is satisfied (S13).

When the ending condition is satisfied (YES in S13), the driving support device 5 ends the processing. When the ending condition is not satisfied (NO in S13), the processes of step S1 and thereafter are repeatedly executed.

<Effect of Second Embodiment>

As described above, according to the second embodiment, vehicle information such as the position, the vehicle length, and the like of the vehicle 60A, 60B traveling on the first lane 101 can be provided to the vehicle 60 traveling on the second lane 102. Accordingly, the vehicle 60 traveling on the second lane 102 can determine a lane changing position and a lane changing timing to the first lane 101. Thus, lane changing of the vehicle 60 can be supported.

[Additional Note]

A computer program for causing a computer to function as the traffic flow measuring device 3 or the driving support device 5 may be stored in a computer-readable non-transitory storage medium such as a HDD, a CD-ROM, or a semiconductor memory, for example.

The computer program described above may be transmitted via a network, data broadcasting, or the like represented by an electric telecommunication line, a wireless or wired communication line, or the Internet.

Each device described above may be realized by a plurality of computers.

A part or the entirety of the functions of each device described above may be provided by cloud computing. That is, a part or the entirety of the functions of each device may be realized by a cloud server. For example, the function of the traffic flow measuring unit 38 of the traffic flow measuring device 3 may be realized by a cloud server, and the traffic flow measuring device 3 may transmit information stored in the storage unit 40 to the cloud server and receive information of the traffic flow from the cloud server.

Further, at least a part of the above embodiments and the above modifications may be combined as desired.

The disclosed embodiments are illustrative in all aspects and should not be recognized as being restrictive. The scope of the present disclosure is defined by the scope of the claims rather than the above-described meaning, and is intended to include meaning equivalent to the scope of the claims and all modifications within the scope.

### REFERENCE SIGNS LIST

1 traffic information providing system
1A traffic information providing system
2 sensor
3 traffic flow measuring device
5 driving support device
10 central device
31 vehicle position measurement unit
32 speed measurement unit
33 vehicle length measurement unit (vehicle size measurement unit)
34 accuracy detection unit
35 vehicle tracking unit
36 vehicle length determination unit
37 vehicle type determination unit
38 traffic flow measuring unit
39 traffic information providing unit
40 storage unit
51 vehicle information providing unit
60 vehicle
60A vehicle
60B vehicle
70 area
100 road
101 first lane
102 second lane
P1 leading end position
P11 rear end position
P12 rear end position
P2 leading end position

1. An information generation device comprising:
a measurement unit configured to obtain a plurality of measurement results by performing a measurement of a vehicle size with respect to a same traveling vehicle a plurality of times;
a detection unit configured to detect an accuracy of each of the plurality of measurement results; and
a determination unit configured to determine a vehicle size of the traveling vehicle from the plurality of measurement results on the basis of the accuracies.

2. The information generation device according to claim 1, wherein
the determination unit is configured to determine, as the vehicle size, a measurement result of which the accuracy is highest among the plurality of measurement results.

3. The information generation device according to claim 1, wherein
the plurality of measurement results are measurement results measured at a plurality of positions, respectively.

4. The information generation device according to claim 3, further comprising
a tracking unit configured to judge vehicles detected at the plurality of positions to be the same traveling vehicle.

5. The information generation device according to claim 1, further comprising
a vehicle type determination unit configured to determine a vehicle type of the traveling vehicle on the basis of the vehicle size determined by the determination unit.

6. The information generation device according to claim 5, further comprising
a measuring unit configured to measure a traffic flow for each vehicle type on the basis of the vehicle type determined by the vehicle type determination unit.

7. The information generation device according to claim 6, wherein
the traffic flow for each vehicle type includes the number of vehicles for each vehicle type.

8. The information generation device according to claim 1, further comprising
a providing unit configured to provide first information based on the vehicle size determined by the vehicle size determination unit.

9. The information generation device according to claim 8, wherein
the first information is further based on a position of the traveling vehicle.

10. The information generation device according to claim 9, wherein
the providing unit is configured to further provide second information indicating a measurement time of the position.

11. The information generation device according to claim 8, wherein
the first information includes inter-vehicle data with respect to a first traveling vehicle and a second traveling vehicle traveling behind the first traveling vehicle,
the vehicle size indicates at least a vehicle length, and
the inter-vehicle data is obtained at least by using the vehicle length indicated by the vehicle size of the first traveling vehicle.

12. The information generation device according to claim 11, wherein
the inter-vehicle data includes at least one of an inter-vehicle distance and an inter-vehicle time length.

13. The information generation device according to claim 11, wherein
the first information is for being provided to a vehicle that is going to enter a lane on which the first traveling vehicle and the second traveling vehicle are traveling.

14. The information generation device according to claim 1, wherein
the vehicle size indicates at least a vehicle length,
the information generation device further includes a providing unit configured to provide first information based on the vehicle length indicated by the vehicle size and a position of the traveling vehicle, and
the first information is for being provided to another vehicle.

15. The information generation device according to claim 1, wherein
each measurement result is obtained on the basis of image data obtained by photographing a road, and
the accuracy is detected on the basis of the number of pixels included in an image of the traveling vehicle in the image data.

16. The information generation device according to claim 1, wherein
each measurement result is obtained on the basis of a cluster of measurement points obtained from a reflected wave of a transmission wave applied to a road by a radar sensor, and
the accuracy is detected on the basis of the number of the measurement points included in the cluster.

17. The information generation device according to claim 1, wherein
each measurement result is obtained on the basis of a reflected wave of a transmission wave applied to a road by a radar sensor, and
the accuracy is detected on the basis of a position of the traveling vehicle of which the vehicle size has been measured.

18. An information generation method comprising:
obtaining a plurality of measurement results by performing a measurement of a vehicle size with respect to a same traveling vehicle a plurality of times;
detecting an accuracy of each of the plurality of measurement results; and
determining a vehicle size of the traveling vehicle from the plurality of measurement results on the basis of the accuracies.

19. A non-transitory computer-readable storage medium having, stored therein, a computer program for causing a computer to operate as an information generation device,
the information generation device comprising:
a measurement unit configured to obtain a plurality of measurement results by performing a measurement of a vehicle size with respect to a same traveling vehicle a plurality of times;
a detection unit configured to detect an accuracy of each of the plurality of measurement results; and
a determination unit configured to determine a vehicle size of the traveling vehicle from the plurality of the vehicle sizes measured, on the basis of the accuracies.
